(19) United States
(12) Patent Application Publication
(10) Pub. No.: US 2008/0037207 A1
(43) Pub. Date: Feb. 14, 2008

(54) SUPPORT STRUCTURE FOR SUPPORTING AN OBJECT

(76) Inventor: Ting-Hui Chih, Hua-Lien City (TW)

Correspondence Address: NORTH AMERICA INTELLECTUAL PROPERTY CORPORATION, P.O. BOX 506, MERRIFIELD, VA, 22116, US

(21) Appl. No.: 11/782,649

(22) Filed: Jul. 25, 2007

(30) Foreign Application Priority Data
Aug. 9, 2006 (TW) 095129171

(51) Int. Cl. F16M 11/10

(52) U.S. Cl. 361/681; 248/125.7

(57) ABSTRACT

A support structure includes a foot piece and an angle control mechanism connected to the foot piece. The angle control mechanism includes a base including an angle-locating pillar, an angle-locating plate and an angle-locating component. The angle-locating plate is pivotally connected to the base in a rotatable manner and fixed to the object. The angle-locating plate has a chute. The angle-locating pillar is disposed inside the chute for constraining a rotating range of the angle-locating plate. The angle-locating component is installed between the base and the angle-locating plate for providing friction force to fix the object and the foot piece in a specific angle while the angle-locating plate is rotating relative to the foot piece.

### BACKGROUND OF THE INVENTION

1. Field of the Invention

The present invention relates to a support structure, and more specifically, to a support structure for supporting an object.

2. Description of the Prior Art

With rapid development of electronic products, convenience of an electronic product has become more and more important. A display device is a representative example. In recent years, the foot piece of a display device has been developed to allow a user to adjust the tilt angle of the screen of the display device. The most common structure is a combination of a foot piece made of plastic material and a spindle for supporting and adjusting the screen.

Traditionally, the foot piece and the spindle are directly installed on the display device so that a user can use the display device immediately after finishing connecting the wiring. However, that will lower portability of the display device. If it changes to a detachable type, portability of the display device will increase. However, that brings the user an annoying assembly process.

### SUMMARY OF THE INVENTION

The present invention discloses a support structure for supporting an object comprising a foot piece having a first endpoint and a second endpoint, an angle control mechanism being installed between the first endpoint and the object, comprising a first base comprising a first angle-locating pillar, the first base being connected to one of the first endpoint and the object; and a first angle-locating plate pivotally connected to the first base in a rotatable manner and connected to one of the object and the first endpoint that is not connected to the first base, the first angle-locating plate having a first chute, the angle-locating pillar being disposed inside the first chute for constraining a rotating range of the angle-locating plate relative to the first base; and a rotating mechanism disposed between the second endpoint and the object for rotating the object relative to the second endpoint, wherein the foot piece constrains the object between the rotating mechanism and the angle control mechanism.

The present invention further discloses a display module comprising a display screen; and a support structure comprising a foot piece having a first endpoint and a second endpoint; an angle control mechanism disposed between the first endpoint and the display screen comprising a first base comprising a first angle-locating pillar, the first base being connected to one of the first endpoint and the display screen; and a first angle-locating plate pivotally connected to the first base in a rotatable manner and connected to one of the display screen and the first endpoint that is not connected to the first base, the first angle-locating plate having a first chute, the angle-locating pillar being disposed inside the first chute for constraining a rotating range of the angle-locating plate relative to the first base; and a rotating mechanism disposed between the second endpoint and the display screen for rotating the display screen relative to the second endpoint, wherein the foot piece constrains the display screen between the rotating mechanism and the angle control mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an assembly diagram of a display module according to a first embodiment of the present invention.

FIG. 2 is an exploded diagram of the first angle control mechanism in FIG. 1.

FIG. 3 is an assembly diagram of a display module according to a second embodiment of the present invention.

FIG. 4 is an assembly diagram of a display module according to a third embodiment of the present invention.

### DETAILED DESCRIPTION

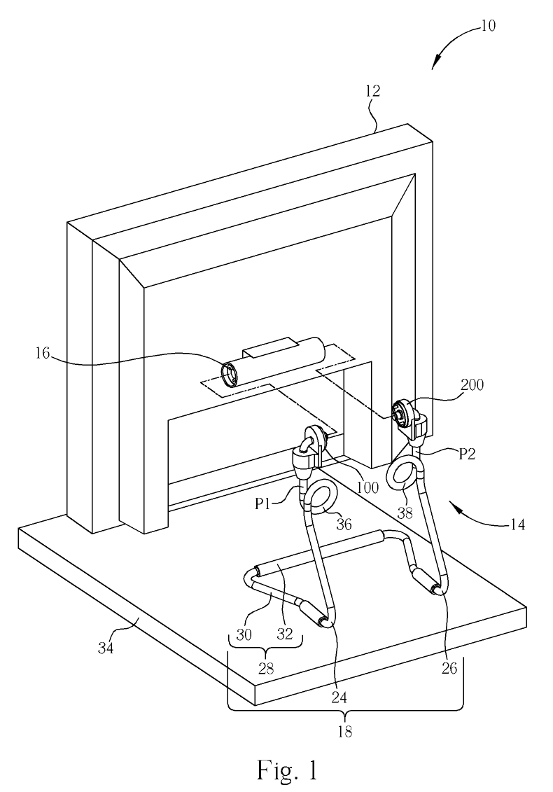

Please refer to FIG. 1. FIG. 1 is an assembly diagram of a display module 10 according to a first embodiment of the present invention. The display module 10 comprises a display screen 12 and a support structure 14. The display screen 12 has at least one tenon hole 16. The support structure 14 comprises a foot piece 18, a first angle control mechanism 100, and a second angle control mechanism 200. The foot piece 18 has a first endpoint P1 and a second endpoint P2. The first angle control mechanism 100 is disposed between the first endpoint P1 and the display screen 12. The second angle control mechanism 200 is disposed between the second endpoint P2 and the display screen 12. The foot piece 18 comprises flexible parts 24 and 26, and a pedestal base 28. The flexible part 24 connects the pedestal base 28 and the first angle control mechanism 100. The flexible part 26 connects the pedestal base 28 and the second angle mechanism 200. The pedestal base 28 comprises a flexible tubular structure 30 and a non-slip sleeve 32. The non-slip sleeve 32 covers the flexible tubular structure 30. When exerting force greater than the weight of the display device 12 upon the flexible tubular structure 30, the contact area between the flexible tubular structure 30 and a plane 34 can be changed. The flexible parts 24 and 26 have ring structures 36 and 38 respectively for increasing the flexibility of the flexible parts 24 and 26. When exerting force greater than the weight of the display device 12 to enlarge the distance between the first endpoint P1 and the second endpoint P2, the display screen 12 can be released from the first endpoint P1 and the second endpoint P2.

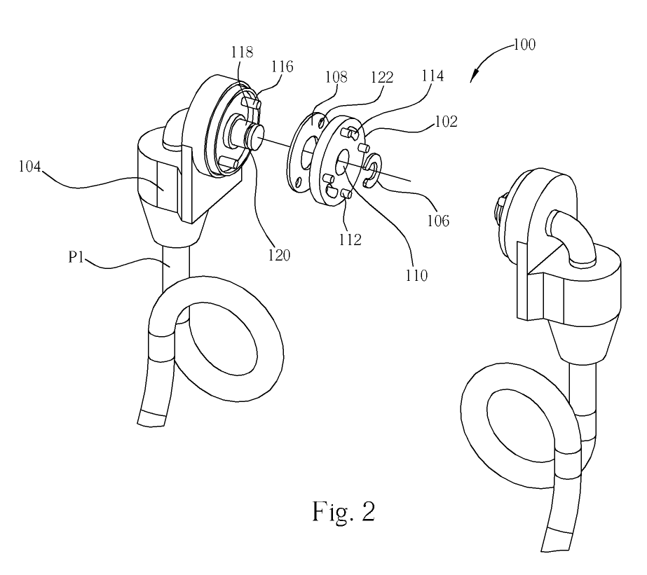

Please refer to FIG. 1 and FIG. 2. FIG. 2 is an exploded diagram of the first angle control mechanism 100 according to a first embodiment of the present invention. The first angle control mechanism 100 is disposed between the first endpoint P1 and the display screen 12 as shown in FIG. 1 for rotating the display screen 12 relative to the first endpoint P1. The first angle control mechanism 100 comprises an angle-locating plate 102, a base 104, a C-shaped ring 106, and an angle-locating component 108. The angle-locating plate 102 connects to the display screen 12. The angle-locating plate 102 comprises a bore 110, at least one locating tenon 112, and a chute 114. The locating tenon 112 is used for inserting into the tenon hole 16 of the display screen 12 as shown in FIG. 1 to fix the connection of the first angle control mechanism 100 and the display screen 12. The base 104 connects to the first endpoint P1. The base 104 comprises at least one angle-locating pillar 116 and a spindle 118. The spindle 118 pivotally connects to the bore 110 so that the angle-locating plate 102 can pivotally connects to the base 104 in a rotatable manner. The spindle 118 has a C-shaped groove 120 thereon. The C-shaped ring 106 is wedged with the C-shaped groove 120 for fixing the connection of the angle-locating plate 102 and the base 104. The angle-locating component 108 is installed between the base 104 and the angle-locating plate 102 for providing friction force to fix the display screen 12 and the foot piece 18 in a specific angle while the angle-locating plate 102 is rotating relative to the base 104. The angle-locating component 108 has at least one hole 112. The angle-locating pillar 116 is disposed inside the chute 114 of the angle-locating plate 102 through the hole 112 for constraining the rotating range of the angle-locating plate 102 relative to the base 104. The angle-locating component 108 can be a friction pad.

The inner structures of the second angle control mechanism 200 and the first angle control mechanism 100 as shown in FIG. 2 are the same. A difference between the first angle control mechanism 100 and the second angle control mechanism 200 is an installed location. The first angle control mechanism 100 is disposed between the first endpoint P1 as shown in FIG. 1 and the display screen 12. The second angle control mechanism 200 is disposed between the second endpoint P2 as shown in FIG. 1 and the display screen 12. The combination of the first angle control mechanism 100, the second angle control mechanism 200, and the display screen 12 allows a user to change the tilt angle of the display screen 12.

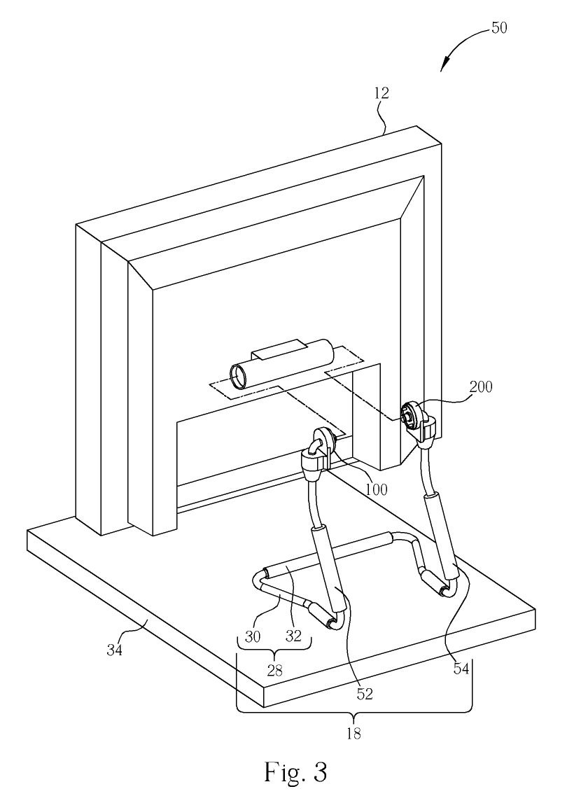

Please refer to FIG. 3. FIG. 3 is an assembly diagram of a display module 50 according to a second embodiment of the present invention. A difference between the display module 50 and the display module 10 in the first embodiment is designs of parts on the support structure. Components mentioned in both the first and the second embodiments represent components with similar functions or similar positions. The foot piece 18 comprises telescopic parts 52 and 54, and a pedestal base 28. The telescopic part 52 connects the pedestal base 28 and the first control mechanism 100. The telescopic part 54 connects the pedestal base 28 and the second control mechanism 200. A user can adjust the distance between the display screen 12 and pedestal base 28 by stretching the telescopic parts 52 and 54.

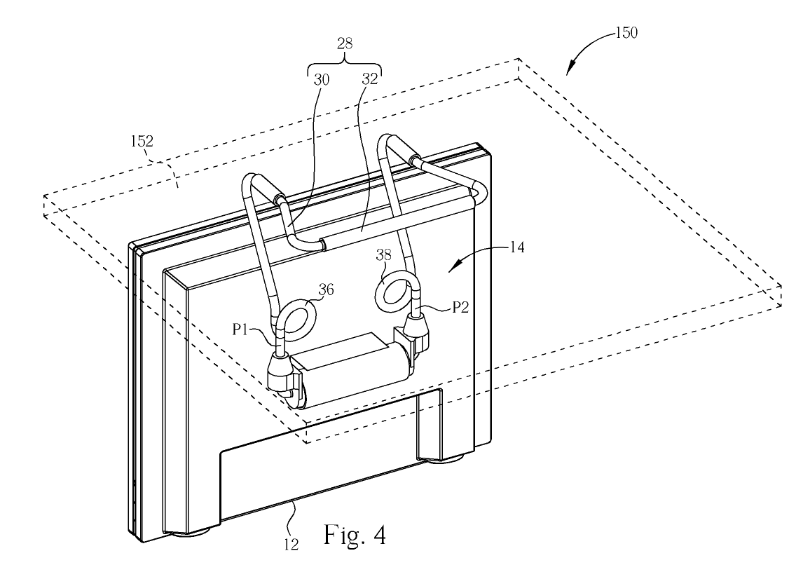

Please refer to FIG. 4. FIG. 4 is an assembly diagram of a display module 150 according to a third embodiment of the present invention. A difference between the display module 150 and the display module 10 in the first embodiment is an assembly angle of the display screen 12 and the support structure 14. Components mentioned in both the first and the third embodiments represent components with similar functions or similar positions. When the display screen 12 and the support structure 14 are combined in an angle as shown in FIG. 1 so that the pedestal base 28 can contact the plane 34, the pedestal base 28 is disposed under the display screen 12 and can support the display screen 12 on the plane 34. And when the first endpoint P1 and the second endpoint P2 is served as a rotational axis to allow the support structure 14 to rotate an angle to be combined with the display screen 12, the pedestal base 28 is disposed above the display screen 12 and can hang the display screen 12 on a hanging plane 152.

The assembly of the first angle control mechanism 100 and the second angle control mechanism 200 is not limited to the embodiments mentioned above. It can also be reversed. For the first angle mechanism 100, the angle-locating plate 102 can connect to the first endpoint P1, and the base 104 can connect to the display screen 12. The locations of the other components in the first angle control mechanism 100 can be changed correspondingly according to the changed locations of the angle-locating plate 102 and the base 104 and the relative positions of the components mentioned in the first embodiment.

The objective of the support structure according to the present invention is that the display screen and the foot piece are detachable. Therefore, compared with a traditional display screen, it is more portable. Furthermore, the foot piece assembles with the display screen through its flexibility. In such a manner, the support structure is easier and quicker to manufacture and assemble.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A support structure for supporting an object comprising:
a foot piece having a first endpoint and a second endpoint;
an angle control mechanism being installed between the first endpoint and the object, comprising:
a first base comprising a first angle-locating pillar, the first base being connected to one of the first endpoint and the object; and
a first angle-locating plate pivotally connected to the first base in a rotatable manner and connected to one of the object and the first endpoint that is not connected to the first base, the first angle-locating plate having a first chute, the angle-locating pillar being disposed inside the first chute for constraining a rotating range of the angle-locating plate relative to the first base; and
a rotating mechanism disposed between the second endpoint and the object for rotating the object relative to the second endpoint, wherein the foot piece constrains the object between the rotating mechanism and the angle control mechanism.

2. The support structure of claim 1, wherein the angle control mechanism further comprises an angle-locating component installed between the first base and the first angle-locating plate for providing friction force to fix the object and the foot piece in a specific angle while the angle-locating plate is rotating relative to the first base.

3. The support structure of claim 1, wherein the rotating mechanism comprises:
a second base comprising a second angle-locating pillar, the second base being connected to one of the second endpoint and the object; and
a second angle-locating plate pivotally connected to the second base in a rotatable manner and connected to one of the object and the second endpoint that is not connected to the second base, the angle-locating plate having a second chute, the second angle-locating pillar being disposed inside the second chute for constraining a rotating range of the second angle-locating plate relative to the second base.

4. The support structure of claim 1, wherein the foot piece comprises a pedestal base, and a telescopic part connecting the pedestal base and the angle control mechanism for adjusting the distance between the object and the pedestal base.

5. The support structure of claim 1, wherein the foot piece comprises a pedestal base, and a flexible part connecting the pedestal base and the angle control mechanism.

6. The support structure of claim 1, wherein the first angle-locating plate further comprises a bore, the first base further comprising a spindle disposed inside the bore so that the first angle-locating plate is pivotally connected to the first base in a rotatable manner.

7. The support structure of claim 6, wherein the spindle has a groove, the angle control mechanism further comprising a ring wedged with the groove for fixing the connection of the angle-locating plate and the first base.

8. The support structure of claim 7, wherein the groove is a C-shaped groove, the ring being a C-shaped ring.

9. The support structure of claim 1, wherein the object has a tenon hole, and the angle-locating plate comprises a locating tenon for inserting into the tenon hole of the object to fix the connection of the angle control mechanism and the object.

10. The support structure of claim 2, wherein the angle-locating component has a hole, the first angle-locating pillar being disposed inside the first chute through the hole.

11. The support structure of claim 2, wherein the angle-locating component is a friction pad for increasing friction force between the first base and the first angle-locating plate to fix the first base and the first angle-locating plate in a specific angle.

12. The support structure of claim 1, wherein the object is a display screen, the first endpoint and the second endpoint being connected to the both sides of the display screen respectively, the combination of the first angle-locating plate and the rotating mechanism allowing a user to change the tilt angle of the display screen.

13. The support structure of claim 5, wherein the flexible part has a ring structure for increasing the flexibility of the flexible part so that the object can be released from the first endpoint and the second endpoint when exerting force to enlarge the distance between the first endpoint and the second endpoint.

14. The support structure of claim 5, wherein the pedestal base comprises a flexible tubular structure and a non-slip sleeve covering the tubular structure wherein the contact area between the flexible tubular structure and a plane can be changed when exerting force upon the flexible tubular structure.

15. The support structure of claim 5, wherein the foot piece is disposed under the object and can support the object on the plane when the first angle-locating plate and the first base are combined in a first angle, and the foot piece is disposed above the object and can hang the object on a hanging plane when the first angle-locating plate and the first base are combined in a second angle.

16. A display module comprising:
a display screen; and
a support structure comprising:
a foot piece having a first endpoint and a second endpoint;
an angle control mechanism disposed between the first endpoint and the display screen comprising:
a first base comprising a first angle-locating pillar, the first base being connected to one of the first endpoint and the display screen; and
a first angle-locating plate pivotally connected to the first base in a rotatable manner and connected to one of the display screen and the first endpoint that is not connected to the first base, the first angle-locating plate having a first chute, the angle-locating pillar being disposed inside the first chute for constraining a rotating range of the angle-locating plate relative to the first base; and
a rotating mechanism disposed between the second endpoint and the display screen for rotating the display screen relative to the second endpoint, wherein the foot piece constrains the display screen between the rotating mechanism and the angle control mechanism.

17. The display module of claim 16, wherein the angle control mechanism further comprises an angle-locating component installed between the first base and the first angle-locating plate for providing friction force to fix the display screen and the foot piece in a specific angle while the angle-locating plate is rotating relative to the first base.

18. The display module of claim 16, wherein the rotating mechanism comprises:
a second base comprising a second angle-locating pillar, the second base connected to one of the second endpoint and the display screen; and
a second angle-locating plate pivotally connected to the second base and connected to one of the display screen and the second endpoint that is not connected to the second base, the angle-locating plate having a second chute, the second angle-locating pillar being disposed inside the second chute for constraining a rotating range of the second angle-locating plate relative to the second base.

19. The display module of claim 16, wherein the foot piece comprises a pedestal base, and a telescopic part connecting the pedestal base and the angle control mechanism for adjusting the distance between the display screen and the pedestal base.

20. The display module of claim 16, wherein the foot piece comprises a pedestal base, and a flexible part connecting the pedestal base and the angle control mechanism.

21. The display module of claim 16, wherein the first angle-locating plate further comprises a bore, the first base further comprising a spindle disposed inside the bore so that the first angle-locating plate is pivotally connected to the first base in a rotatable manner.

22. The display module of claim 21, wherein the spindle has a groove, the angle control mechanism further comprising a ring wedged with the groove for fixing the connection of the angle-locating plate and the first base.

23. The display module of claim 22, wherein the groove is a C-shaped groove, the ring being a C-shaped ring.

24. The display module of claim 16, wherein the object has a tenon hole, and the angle-locating plate comprises a locating tenon for inserting into the tenon hole of the display screen to fix the connection of the angle control mechanism and the display screen.

25. The display module of claim 17, wherein the angle-locating component has a hole, the first angle-locating pillar being disposed inside the first chute through the hole.

26. The display module of claim 17, wherein the angle-locating component is a friction pad for increasing friction force between the first base and the first angle-locating plate to fix the first base and the first angle-locating plate in a specific angle.

27. The display module of claim 16, wherein the first endpoint and the second endpoint being connected to the both sides of the display screen respectively, the combination of the first angle-locating plate and the rotating mechanism allowing a user to change the tilt angle of the display screen.

28. The display module of claim 20, wherein the flexible part has a ring structure for increasing the flexibility of the flexible part so that the display module can be released from the first endpoint and the second endpoint when exerting force to enlarge the distance between the first endpoint and the second endpoint.

29. The display module of claim 20, wherein the pedestal base comprises a flexible tubular structure and a non-slip sleeve covering the tubular structure wherein the contact area between the flexible tubular structure and a plane can be changed when exerting force upon the flexible tubular structure.

30. The display module of claim 20, wherein the foot piece is disposed under the display screen and can support the display screen on the plane when the first angle-locating plate and the first base are combined in a first angle, and the foot piece is disposed above the display screen and can hang the display screen on a hanging plane when the first angle-locating plate and the first base are combined in a second angle.
